(19) United States
(12) Patent Application Publication
(10) Pub. No.: US 2021/0356356 A1
(43) Pub. Date: Nov. 18, 2021

(54) MULTI-DISTANCE TESTING DEVICE

(71) Applicant: TRIPLE WIN TECHNOLOGY(SHENZHEN) CO.LTD., Shenzhen (CN)

(72) Inventors: YEN-SHENG LIN, New Taipei (TW); ZU-FENG LE, Shenzhen (CN); YU-TSANG TU, New Taipei (TW); ZU-WEI CAO, Shenzhen (CN)

(21) Appl. No.: 17/038,154

(22) Filed: Sep. 30, 2020

(30) Foreign Application Priority Data
May 13, 2020 (CN) 202010403744.3

(51) Int. Cl. G01M 11/04; G01M 11/02

(52) U.S. Cl. CPC G01M 11/04; G01M 11/0221

(57) ABSTRACT

A multi-distance testing device includes a testing machine supporting a to-be-tested component, a first guide rail located on one side of the testing machine, a mobile platform connected to the first guide rail and capable to slide back and forth on the first guide rail, a fixing frame fixed on the mobile platform, a display screen fixed on the fixing frame and displaying test charts, a relay lens located between the display screen and the testing machine, and a control system electrically connected or signal connected to the display screen. The relay lens shortens a test distance to construct an infinite test distance in a limited space. The control system drives the mobile platform to move to the first designated position and controls the display screen to switch and display different test charts according to the distance between the display screen and the testing machine.

### FIELD

The subject matter of the application generally relates to a multi-distance testing device.

### BACKGROUND

Before the lenses are assembled on mobile phones, computers, and other devices, the lenses need to be tested at multiple distances. In a related art, the lens is usually being tested by installing the lens on a testing machine. Platforms with 210 mm, 28 mm, 840 mm and infinite distances are built around the testing machine at the same time. Test charts are installed on the platforms at different distances. The test charts have different sizes and are fixed on the platforms by frames of matching sizes. Center positions of the testing machine and the lens to be tested are aligned. The test machine has a large volume, not easy to operate, and a testing accuracy of the less is not high. In addition, if the size of the test chart is changed, test charts corresponding to the size and design requirements needs to be repurchased, which may cause an additional cost.

Therefore, there is room for improvement in the art.

### BRIEF DESCRIPTION OF THE DRAWINGS

Implementations of the present disclosure will now be described, by way of embodiments, with reference to the attached figures.

FIG. 1 is a perspective view of an embodiment of a multi-distance testing device according to the present disclosure.

FIG. 2 is a perspective view of a plurality of elements of the multi-distance testing device of FIG. 1.

FIG. 3 is a perspective view of a test chart of the multi-distance testing device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain portions may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like.

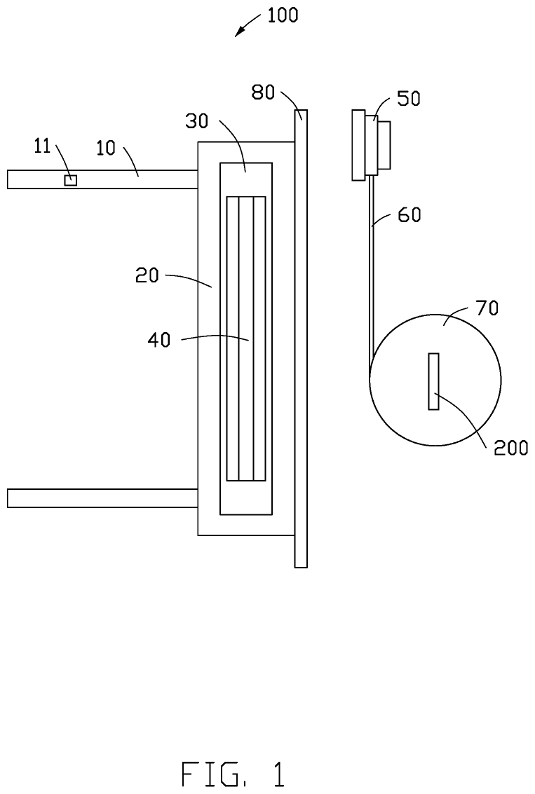

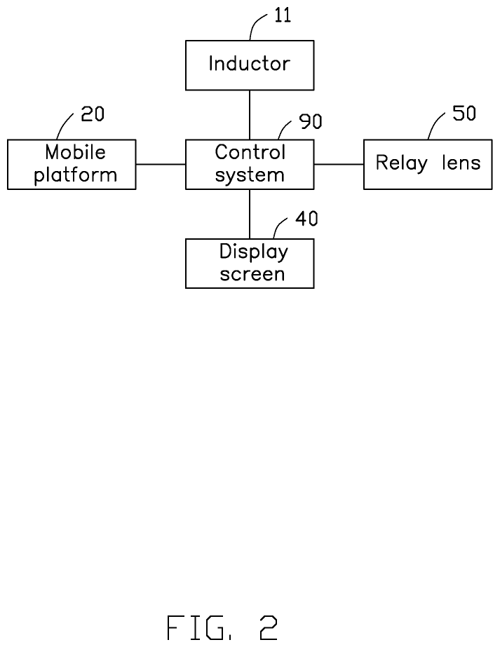

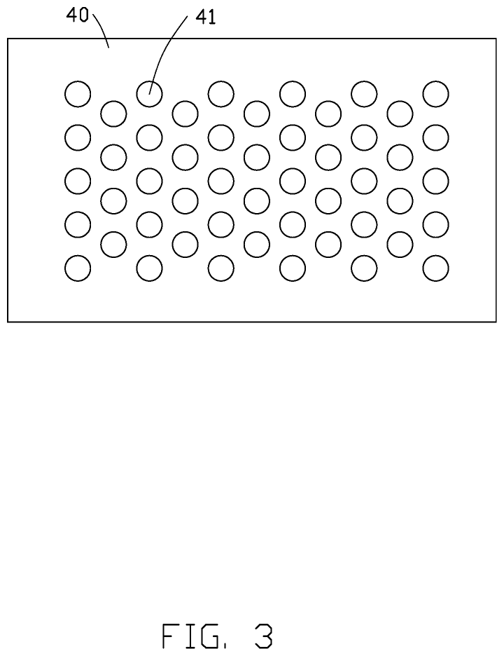

FIGS. 1-3 show an embodiment of a multi-distance testing device 100. The multi-distance testing device 100 is used to test lenses.

Referring to FIG. 1, the multi-distance testing device 100 includes a first guide rail 10, a mobile platform 20, a fixing frame 30, a display screen 40, a relay lens 50, a testing machine 70, and a control system 90. The first guide rail 10 is located on one side of the testing machine 70. The mobile platform 20 is connected to the first guide rail 10 and is capable to slide back and forth on the first guide rail 10. The fixing frame 30 is fixed on the mobile platform 20. The display screen 40 is fixed on the fixing frame 30. The relay lens 50 is located between the display screen 40 and the testing machine 70. The control system 90 is electrically connected or signal connected to the display screen 40.

In at least one embodiment, the first guide rail 10 is a bidirectional guide rail.

In at least one embodiment, the first guide rail 10 is a linear guide rail, such as a roller linear guide rail, a cylindrical linear guide rail, or a ball linear guide rail.

In at least one embodiment, a length of the first guide rail 10 is 1 meter.

The multi-distance testing device 100 further includes a plurality of inductors 11 formed on the first guide rail 10 or located on one side of the first guide rail 10. Each of the plurality of inductors 11 is corresponding to a testing distance. The plurality of inductors 11 is electrically connected or signal connected to the control system 90. The plurality of inductors 11 sense whether the mobile platform 20 has been accurately moved to a first designated position. If the position of the mobile platform 20 deviates from the first designated position, the control system 90 controls the plurality of inductors 11 to sound alarm.

The fixing frame 30 has a screw adjustment structure (not shown). The screw adjustment structure is used to adjust a position of the display screen 30.

The display screen 40 is used to display a test chart 41. The display screen 40 is one of a liquid crystal display screen, an organic light emitting diode display screen, and the like.

The relay lens 50 is used to shorten a test distance to construct an infinite test distance in a limited space. The relay lens 50 can be capable of moving in a direction perpendicular to an extending direction of the first guide rail 10.

In at least one embodiment, the multi-distance testing device 100 further includes a second guide rail 60.

The second guide rail 60 is arranged between the mobile platform 20 and the testing machine 70. The relay lens 50 is connected to the second guide rail 60 and capable of sliding back and forth on the second guide rail 60.

In at least one embodiment, an extending direction of the second rail 60 is perpendicular to the extending direction of the first rail 10.

In at least one embodiment, the second rail 60 is a monorail rail.

The second guide rail 60 is a linear guide rail, such as a roller linear guide rail, a cylindrical linear guide rail, or a ball linear guide rail.

In other embodiments, the relay lens 50 may also slid in other ways, such as a slide, a grab device, and so on.

The testing machine 70 is used to support a to-be-tested component 200.

The control system 90 is also electrically or signally connected to the mobile platform 20, the plurality of inductors 11, and the relay mirror 50.

The control system 90 is used to drive the mobile platform 20 to move to the first designated position.

The control system 90 controls the display screen 40 to switch and display different test charts 41 according to the distance between the display screen 40 and the testing machine 70.

The control system 90 controls the relay lens 50 to slide on the second guide rail 60 to a second designated position when the relay lens 50 is required to construct an infinite test distance.

The multi-distance testing device 100 further includes an anti-reflective plate 80 formed on the mobile platform 20. The anti-reflective plate 80 is located between the display screen 40 and the testing machine 70. In at least one embodiment, the anti-reflective plate 80 is a black anti-reflective plate with holes. The anti-reflective plate 80 is used to form a field of view requirement for testing.

With the embodiments described above, firstly, the mobile platform 20, cooperates with the guide rail 10 and the relay lens 50 can construct a plurality of different test distances, so that the multi-distance testing device 100 has a little volume and can save workshop space. Secondly, the display screen 40 can display and change different test charts 41, which is not only simple to operate, reduces additional cost, but also can meet the different design requirements of different lenses. Thirdly, the plurality of inductors 11 and formed on the first guide rail 10 or located on one side of the first guide rail 10 can ensure the test distance is accurate. Fourthly, the fixing frame can accurately adjust the position of the display screen 40. Fifthly, the display screen is easy to clean and not easy to stain, if you need to change a different test distance, the test chart can be switched directly through the control system 90, which is convenient and quick. Sixthly, other test stations, such as dark environment test and color test can be added on sides of the mobile platform 20, so that a test environment of the multi-distance testing device 100 is more abundant.

The embodiments shown and described above are only examples. Many details are often found in the art such as the other features of a multi-distance testing device. Therefore, many such details are neither shown nor described. Even though numerous characteristics and advantages of the present disclosure have been positioned forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims. It will therefore be appreciated that the embodiments described above can be modified within the scope of the claims.

What is claimed is:

1. A multi-distance testing device comprising:
a testing machine configured to support a component;
a first guide rail on one side of the testing machine;
a mobile platform connected to the first guide rail, the mobile platform being slidable on the first guide rail;
a fixing frame fixed on the mobile platform;
a display screen fixed on the fixing frame and configured to display test charts;
a relay lens between the display screen and the testing machine; wherein the relay lens shortens a test distance to construct an infinite test distance in a predetermined space; and
a control system electrically connected or signal connected to the display screen; wherein the control system drives the mobile platform to move to a first designated position and controls the display screen to switch and display different test charts according to a distance between the display screen and the testing machine.

2. The multi-distance testing device of claim 1, further comprising a plurality of inductors on the first guide rail or on one side of the first guide rail; wherein each of the plurality of inductors is corresponding to a testing distance; the plurality of inductors is electrically connected or signal connected to the control system; the plurality of inductors sense whether the mobile platform has been moved to a first designated position and sound alarm when the position of the mobile platform deviates from the first designated position.

3. The multi-distance testing device of claim 1, wherein the relay mirror is electrically or signally connected to the control system, and the control system controls the relay lens to a second designated position when the relay lens constructs an infinite test distance.

4. The multi-distance testing device of claim 3, wherein the relay lens is movable in a direction perpendicular to an extending direction of the first guide rail.

5. The multi-distance testing device of claim 3, further comprising a second guide rail; wherein the relay lens is connected to the second guide rail and slidable on the second guide rail; and the control system controls the relay lens to slide on the second guide rail to the second designated position when the relay lens constructs an infinite test distance.

6. The multi-distance testing device of claim 5, wherein an extending direction of the second guide rail is perpendicular to an extending direction of the first rail.

7. The multi-distance testing device of claim 5, wherein the first guide rail is a bidirectional guide rail and the second guide rail is a monorail rail.

8. The multi-distance testing device of claim 1, further comprising an anti-reflective plate on the mobile platform.

9. The multi-distance testing device of claim 1, wherein the first guide rail is one of a roller linear guide rail, a cylindrical linear guide rail, and a ball linear guide rail.

10. The multi-distance testing device of claim 1, wherein the display screen is a liquid crystal display screen or an organic light emitting diode display screen.
